(19) United States
(12) Patent Application Publication
(10) Pub. No.: US 2017/0213533 A1
(43) Pub. Date: Jul. 27, 2017

(54) DONGLE DEVICE FOR AUDIO/MUSIC DEVICE

(71) Applicant: Quicco Sound Corporation, Shizuoka (JP)

(72) Inventors: Makoto Hiroi, Shizuoka (JP); Takeshi Ando, Shizuoka (JP)

(73) Assignee: Quicco Sound Corporation, Shizuoka (JP)

(21) Appl. No.: 15/104,746

(22) PCT Filed: Feb. 25, 2015
(86) PCT No.: PCT/JP2015/055437

§ 371 Date: Jun. 15, 2016

(30) Foreign Application Priority Data
Mar. 19, 2014 (JP) 2014-055798

(51) Int. Cl. G10H 1/00

(52) U.S. Cl. CPC G10H 1/0066; G10H 1/0083; G10H 2230/035; G10H 2240/311

(57) ABSTRACT

A dongle device includes a dongle input terminal connected to an MIDI output terminal of an audio-music device, a dongle output terminal connected to an MIDI input terminal of the audio-music device, communication means exchanging various electronic information between the audio-music device and the other electronic device via the dongle input terminal and the dongle output terminal, and a power-supply circuit which obtains power from a signal line in the MIDI scheme from the audio-music device via the dongle input terminal, supplies the power to the communication means, and outputs the power to the MIDI input terminal of the audio-music device via the dongle output terminal.

### TECHNICAL FIELD

The present disclosure relates to a dongle device for audio-music devices which exchanges, with other electronic devices, various electronic information held by an audio-music device using a signal format that is the MIDI scheme.

### BACKGROUND ART

Conventionally, the musical instrument digital interface (MIDI) scheme has been proposed which is a signal format for exchanging, with other electronic devices, various electronic information held by an audio-music device. For example, an electronic musical instrument is electronically connected to an information processing terminal like a computer (see Patent Literature 1).

As for the connection between an audio-music device and the other electronic device in the conventional MIDI scheme, in many cases, a cable is applied. In addition, since each device has the own power supply, a consideration for a power supply to each device is unnecessary.

### CITATION LIST

### Patent Literature

Patent Literature 1: Unexamined Japanese Patent Application Kokai Publication No. H07-44169

### SUMMARY OF INVENTION

### Technical Problem

However, according to the conventional connection configuration in the MIDI scheme, when communication means like wireless means is applied for the connection between an audio-music device and the other electronic device instead of a cable, and when a device intervening between the audio-music device and the other electronic device is a compact device so as to have no power supply or to be unable to have the own power supply, power for the intervening device is not ensured.

The present disclosure has been made in view of the foregoing circumstances, and an objective of the present disclosure is to provide a dongle device for audio-music devices which ensures power even if a device including communication means intervening between an audio-music device and the other electronic device is compact so as to have no power supply or to be unable to have the own power supply, and which is capable of exchanging various electronic information between the audio-music device and the other electronic device in both IN and OUT directions in the MIDI scheme from the audio-music device.

### Solution to Problem

A dongle device for audio-music devices as recited in claim 1 includes:

a dongle input terminal that is to be connected to an MIDI output terminal of an audio-music device;

a dongle output terminal that is to be connected to an MIDI input terminal of the audio-music device;

communication means that exchanges various electronic information between the audio-music device and the other electronic device via the dongle input terminal and the dongle output terminal; and

a power-supply circuit that obtains power from a signal line in the MIDI scheme from the audio-music device via the dongle input terminal, supplies the power to the communication means, and outputs the power to the MIDI input terminal of the audio-music device via the dongle output terminal.

According to the dongle device for audio-music devices as recited in claim 2, the power-supply circuit:

obtains the power from a power-supply signal line in the MIDI scheme from the audio-music device via the dongle input terminal;

supplies the obtained power to the communication means; and

supplies the power to a power-supply signal line of the MIDI input terminal of the audio-music device via the dongle output terminal.

According to the dongle device for audio-music devices as recited in claim 3, the communication means includes master-slave changing means that changes a master and a slave with communication means of the other electronic device.

According to the dongle device for audio-music devices as recited in claim 4:

the communication means includes pairing means that mutually exchanges authentication codes with communication means of the other electronic device to execute pairing; and

upon operation given to a pairing start switch provided in the paring means, execution of the pairing starts.

According to the dongle device for audio-music devices as recited in claim 5:

the power-supply circuit includes charging means; and

the power-supply circuit controls charging and discharging of the charging means to output power.

According to the dongle device for audio-music devices as recited in claim 6, the communication means includes wireless means.

### Advantageous Effects of Invention

According to the present disclosure, power is obtained from the signal line in the MIDI scheme from the audio-music device via the dongle input terminal, the power is supplied to the communication means, and the power is also output to the MIDI input terminal of the audio-music device via the dongle output terminal. Hence, even if a device including communication means intervening between the audio-music device and the other electronic device is compact so as to have no power supply or to be unable to have the own power supply, power is ensured, and various electronic information can be exchanged between the audio-music device and the other electronic device in both IN and OUT directions in the MIDI scheme from the audio-music device.

### BRIEF DESCRIPTION OF DRAWINGS

FIG. 1 is a configuration diagram illustrating an example system configuration for a dongle device for audio-music devices according to the present disclosure;

FIG. 2 is a configuration diagram illustrating an example configuration of the dongle device for audio-music devices; and

FIG. 3 is a configuration diagram illustrating another example configuration of the dongle device for audio-music devices.

### DESCRIPTION OF EMBODIMENTS

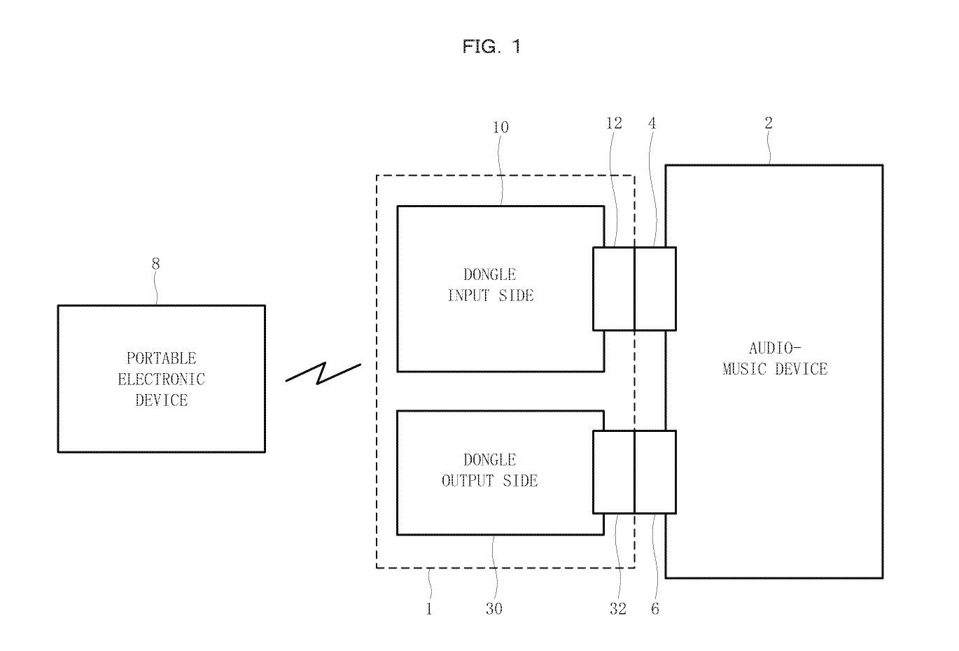

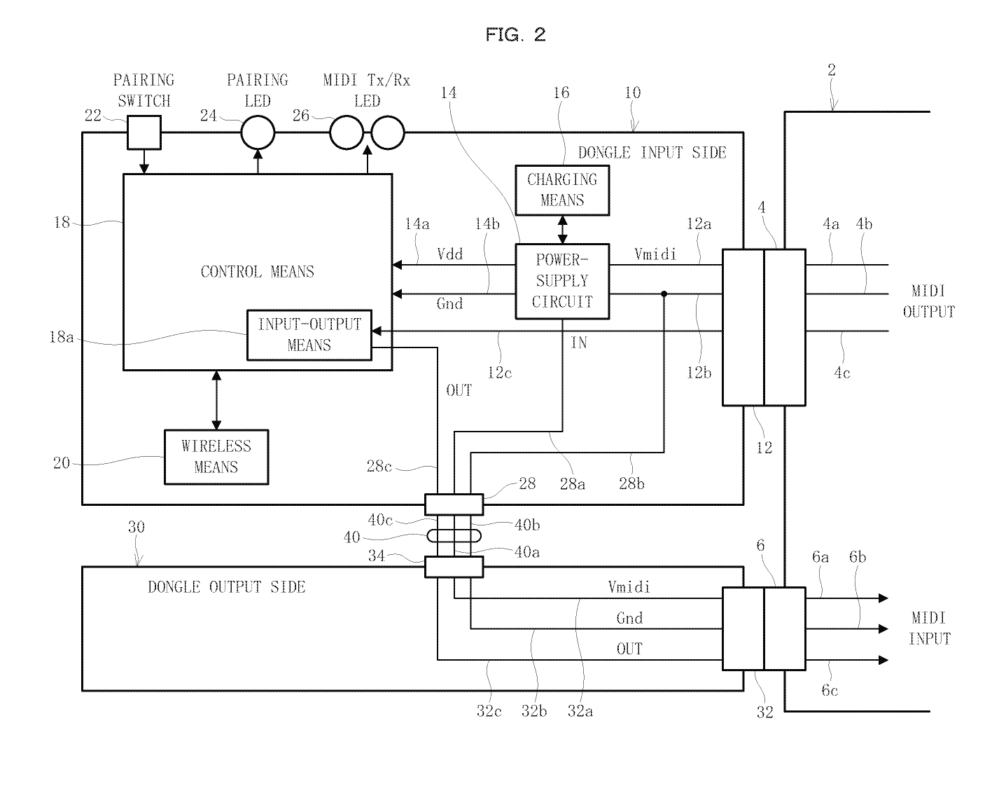

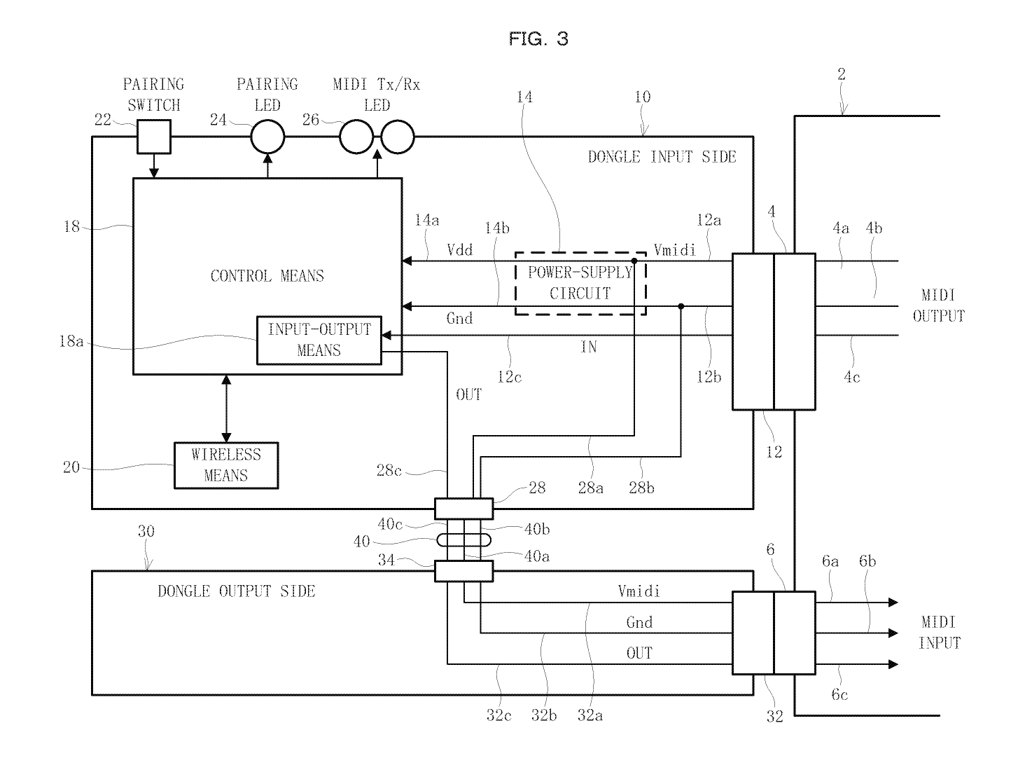

An embodiment of the present disclosure will be explained below in detail with reference to the figures. FIG. 1 is a configuration diagram illustrating an example system configuration for a dongle device for audio-music devices according to the present disclosure. FIG. 2 is a configuration diagram illustrating an example configuration of the dongle device for audio-music devices. FIG. 3 is a configuration diagram illustrating another example configuration of the dongle device for audio-music devices. The example system configuration illustrated in FIG. 1 includes a dongle device 1 for audio-music devices, an audio-music device 2, and a portable electronic device 8.

The dongle device 1 for audio-music devices in the figure is to exchange, with other electronic devices, various electronic information held by the audio-music device 2 using a signal format that is a musical instrument digital interface (MIDI) scheme. Example audio-music devices 2 are musical instruments, such as an electronic keyboard (electronic organ) and an electronic guitar, and electronic devices that are capable of processing music and audio like an effector. The audio-music device 2 includes an MIDI output terminal 4 and an MIDI input terminal 6 for exchanging, with other electronic devices, various electronic information through the signal format that is the MIDI scheme.

An example signal format for the MIDI output terminal 4 and the MIDI input terminal 6 is a current loop format, and internally connected to the MIDI output terminal 4 of the audio-music device 2 are a Vmidi line 4a that is a power-supply signal line where a current is supplied from the audio-music device 2, a Gnd line 4b, and an OUT line 4c that is a signal output from the audio-music device 2. In addition, internally connected to the MIDI input terminal 6 are, inversely relative to the MIDI output terminal 4, a Vmidi line 6a that is a power-supply signal line, a Gnd line 6b, and an IN line 6c.

The portable electronic device 8 is an electronic device that exchanges various electronic information with the audio-music device 2, and is capable of electronically exchanging electronic information in the MIDI scheme (MIDI code format). In addition, the portable electronic device 8 has a function of wirelessly exchanging electronic information in the MIDI scheme with wireless means 20 that is the communication means of the dongle device 1 for audio-music devices to be explained later. The communicable wireless format will be explained later. Note that the portable electronic device 8 is an example electronic device that is capable of exchanging various electronic information held by the audio-music device 2 in the MIDI scheme (MIDI code format), and may be a computer or a gaming device, and the configuration thereof is not limited to any particular one. In addition, according to this embodiment, the wireless means 20 is applied as the communication means to exchange various electronic information between the audio-music device 2 and the portable electronic device 8 via a dongle input terminal 12 and a dongle output terminal 32, but the communication means is not limited to the wireless means, and may be communication means capable of, for example, establishing a connection by a cable in the USB scheme, and the configuration is not limited to any particular one.

The dongle device 1 for audio-music devices employs a configuration in which a dongle input side 10 and a dongle output side 30 are separate blocks. The dongle input side 10 includes the dongle input terminal 12 connected to the MIDI output terminal 4 of the audio-music device 2, while the dongle output side 30 includes a dongle output terminal 32 connected to the MIDI input terminal 6 of the audio-music device 2. In addition, the dongle input side 10 and the dongle output side 30 are connected to each other via connection means 40. Note that according to the dongle device 1 for audio-music devices in this embodiment, the dongle input side 10 and the dongle output side 30 are separate blocks, but may be an integral block.

The dongle device 1 for audio-music devices includes, in the dongle input side 10, a power-supply circuit 14, control means 18, the wireless means 20, and the like, in addition to the dongle input terminal 12. The power-supply circuit 14 is connected to a Vmidi line 12a and a Gnd line 12h from the dongle input terminal 12, and obtains power from the Vmidi line 4a that is a signal line of the MIDI output terminal 4 of the audio-music device 2. In addition, the power-supply circuit 14 supplies the obtained power via the Vmidi line 12a to the control means 18 and the wireless means 20 via a Vdd line 14a and a Gnd line 14b.

The power-supply circuit 14 includes charging means 16 like storage batteries or super capacitors, and is capable of charging means 16 using the obtained power via the Vmidi line 12a. In addition, when the obtained power via the Vmidi line 12a is little, the charging means 16 is caused to discharge the power, thereby supplying necessary power to the control means 18 and the wireless means 20. Since the power-supply circuit 14 has the charging-discharging control function and also the charging means 16 as explained above, stable power can be supplied, but the charging-discharging control functions in the charging means 16 and in the power-supply circuit 14 are not essential. In addition, the power-supply circuit 14 may have a function of boosting and bucking the voltage of power from the Vmidi line 12a, to a preferable voltage for the control means 18 and the like so as to obtain stable power.

The power-supply circuit 14 supplies power to the wireless means 20, and outputs power to the Vmidi line 6a of the MIDI input terminal 6 of the audio-music device 2 via the dongle output terminal 32 (via Vmidi line 28a, dongle connection terminal 28, Vmidi line 40a, and Vmidi line 32a). That is, the power-supply circuit 14 obtains power from the Vmidi line 12a that is a power-supply signal line in the MIDI scheme from the audio-music device 2 via the dongle input terminal 12, supplies the obtained power to the wireless means 20 that is the communication means, and is also capable of supplying power to the Vmidi line 6b that is a power-supply signal line of the MIDI input terminal 6 of the audio-music device 2 via the dongle output terminal 32. Note that when the voltage and the current at the Vmidi line 4a of the audio-music device 2 are originally suitable for the supply to the wireless means 20 and the Vmidi line 6b, the power-supply circuit 14 needs no booster or bucking circuit, and as illustrated in FIG. 3, the power-supply circuit 14 can be simply connected to each Vmidi line.

The control means 18 is a general device like a CPU or an MPU that controls the electronic device, and according to the dongle device 1 for audio-music devices in this embodiment, is actuated upon supplied power from the power-supply circuit 14, and controls the wireless means 20 and input-output means 18a that serves as an internal function, and the like. The input signal from the audio-music device 2 (OUT line 4c and IN line 12c as signal lines) reaches input-output means 18a of the control means 18 via the dongle input terminal 12, is recognized as electronic information in the MIDI scheme in the control means 18, and the electronic information is controlled so as to be sent to the wireless means 20 and to be transmitted to the portable electronic device 8 from the wireless means 20.

In addition, the received electronic information from the portable electronic device 8 by the wireless means 20 is recognized by the control means 18, and is sent to the audio-music device 2 as the electronic information in the MIDI scheme from the input-output means 18a via the dongle output terminal 32 of the dongle output side 30. The output signal by the input-output means 18a (OUT line 28c as signal line) reaches the dongle output side 30 via the dongle connection terminal 28, inter-dongle connection means 40 (OUT line 40c as signal line), and the dongle connection terminal 34. Next, the output signal is, at the dongle output side 30, input to the audio-music device 2 via the MIDI input terminal 6 of the audio-music device 2 through a route passing through the dongle connection terminal 34 and to the dongle output terminal 32 via an OUT line 32c.

The dongle input side 10 is provided with a pairing switch 22 that has the input and the output controlled by the control means 18, pairing display means (pairing LED) 24 and MIDI transmission-reception display means (MIDI Tx/Rx LED) 26. The MIDI transmission-reception display means (MIDI Tx/Rx LED) 26 is a display for monitoring the status of exchanging the electronic information in the MIDI scheme between the audio-music device 2 and the portable electronic device 8 via the dongle device 1 for audio-music devices, but is not essential.

In addition, the pairing switch 22 that is a pairing start switch is a paring start switch for causing the wireless means 20 to function pairing means which mutually exchanges authentication codes with the wireless means of the other electronic device to start pairing. That is, when the paring switch 22 is operated, pairing is executed. Note that the paring switch 22 may be a switch that is realized by a mechanical structure, or may be a switch that turns ON/OFF by a magnet using Hall elements, and the structure is not limited to any particular one. According to the dongle device 1 for audio-music devices in this embodiment, the function of the pairing means is accomplished by controlling the wireless means 20 from the control means 18. The pairing display means (pairing LED) 24 is a monitor for displaying whether or not the pairing means is executing pairing. Note that the pairing means, the paring switch 22 that is the paring start switch, and the pairing display means (pairing LED) 24 are not always requisite depending on the format of the wireless means 20, and the like.

According to the dongle device 1 for audio-music devices in this embodiment, the control means 18 is provided to control the wireless means 20 or the like that is the communication means, but when the wireless means 20 has a capability of, for example, controlling various signals, the control means 18 may be unnecessary, and thus the control means 18 itself is not essential.

The wireless means 20 wirelessly transmits the obtained electronic information from the audio-music device 2 via the dongle input terminal 12 to the portable electronic device 8 that is the other electronic device, and transmits the received electronic information from the portable electronic device 8 that is the other electronic device to the audio-music device 2 via the dongle output terminal 32. The signal format applicable to the wireless means 20 and the wireless means is not always the MIDI scheme, and various electronic information that has been exchanged with the portable electronic device 8 may be converted in the MIDI scheme in the control means 18 or in the wireless means 20, enabling an exchange with the audio-music device 2 in the signal format that is in the MIDI scheme.

Example wireless formats for the wireless means 20 applicable are Bluetooth (registered trademark) and wireless LAN, and the like, but the present disclosure is not limited to such format. In addition, a term wireless means is adopted in this specification, but this wireless means widely covers means that is capable of exchanging various electronic information in a non-contact scheme, and for example, an optical scheme, a magnetic scheme, and the like, are also in the scope of the term wireless means.

In addition, the control means 18 may control the wireless means 20, or the wireless means 20 may alone accomplish a function as master-slave changing means for changing the master and the slave with the wireless means of the portable electronic device 8 that is the other electronic device. Such a function may be provided in either the control means 18 or the wireless means 20.

According to the dongle device 1 for audio-music devices employing the above configuration, even if a device provided with communication means intervening between the audio-music device 2 and the portable electronic device 8 that is the other electronic device is compact so as to have no power supply or to be unable to have the own power supply, various electronic information can be exchanged between the audio-music device 2 and the portable electronic device 8 in both IN and OUT directions of the MIDI scheme from the audio-music device 2 while power is ensured.

Note that in this specification, although the explanation has been given of a case in which, as the counterparty with which the audio-music device 2 exchanges various electronic information, the portable electronic device 8 or the like is the other electronic device that is not an audio-music device, the audio-music device itself that is capable of handling signal formats in the MIDI scheme is a kind of electronic device, and thus the other device includes audio-music devices by rights. As an example, two audio-music devices are provided with respective dongle devices 1 for audio-music devices, and electronic information is exchanged between the audio-music devices via the two dongle devices 1 for audio-music devices. In this case, the two audio-music devices need no cable for connection, and thus the degree of freedom for the layout of the audio-music devices increases.

In addition, in the foregoing explanation, the power-supply circuit 14, the control means 18, and the wireless means 20, and the like, are provided at the dongle input side 10, but when the dongle input side 10 and the dongle output side 30 are provided simultaneously (aforementioned embodiment) or provided integrally except a configuration in which the dongle input side 10 alone is provided, all of or some of the power-supply circuit 14, the control means 18, the wireless means 20, and the like, may be provided at the dongle output side 30.

Still further, master-slave changing means that changes the master and the slave with the wireless means of the other electronic device may be further provided, and pairing means that mutually exchanges authentication codes with the wireless means of the other electronic device to execute a pairing may be further provided. This assists a smooth communication between the respective wireless means, thereby improving the user-friendliness.

This application is based on Japanese Patent Application No. 2014-055798 filed on Mar. 19, 2014. The entire specification, claims, and drawings of Japanese Patent Application No. 2014-055798 are herein incorporated in this specification by reference.

### INDUSTRIAL APPLICABILITY

As explained above, according to the present disclosure, a dongle device for audio-music devices is provided which ensures power even if a device including communication means intervening between an audio-music device and the other electronic device is compact so as to have no power supply or to be unable to have the own power supply, and which is capable of exchanging various electronic information between the audio-music device and the other electronic device in both IN and OUT directions in the MIDI scheme from the audio-music device.

### REFERENCE SIGNS LIST

1 Dongle device for audio-music devices
2 Audio-music device
4 MIDI output terminal
4a Vmidi line
4b Gnd line
4c OUT line
6 MIDI input terminal
6a Vmidi line
6b Gnd line
6c IN line
8 Portable electronic device
10 Dongle input side
12 Dongle input terminal
12a Vmidi line
12b Gnd line
12c IN line
14 Power-supply circuit
14a Vdd line
14b Gnd line
16 Charging means
18 Control means
18a Input-output means
20 Wireless means
22 Pairing switch
24 Pairing display means
26 MIDI transmission-reception display means
28 Dongle connection terminal
28a Vmidi line
28b Gnd line
28c OUT line
30 Dongle output side
32 Dongle output terminal
32a Vmidi line
32b Gnd line
32c OUT line
34 Dongle connection to
40 Inter-dongle connection means
40a Vmidi line
40b Gnd line
40c OUT line

1. A dongle device for audio-music devices which exchanges, with other electric device, various electronic information held by an audio-music device using a signal format that is an MIDI scheme, the dongle device comprising:
a dongle input terminal that is to be connected to an MIDI output terminal of the audio-music device;
a dongle output terminal that is to be connected to an MIDI input terminal of the audio-music device;
communication means that exchanges various electronic information between the audio-music device and the other electronic device via the dongle input terminal and the dongle output terminal; and
a power-supply circuit that obtains power from a signal line in the MIDI scheme from the audio-music device via the dongle input terminal, supplies the power to the communication means, and outputs the power to the MIDI input terminal of the audio-music device via the dongle output terminal.

2. (canceled)

3. The dongle device for audio-music devices according to claim 1, wherein the communication means comprises master-slave changing means that changes a master and a slave with communication means of the other electronic device.

4. The dongle device for audio-music devices according to claim 1, wherein:
the communication means comprises pairing means that mutually exchanges authentication codes with communication means of the other electronic device to execute pairing; and
upon operation given to a pairing start switch provided in the paring means, execution of the pairing starts.

5. The dongle device for audio-music devices according to claim 1, wherein:
the power-supply circuit comprises charging means; and
the power-supply circuit controls charging and discharging of the charging means to output power.

6. The dongle device for audio-music devices according to claim 1, wherein the communication means comprises wireless means.

7. A dongle device for audio-music devices which exchanges, with other electric device, various electronic information held by an audio-music device using a signal format that is an MIDI scheme, the dongle device comprising:
a dongle input terminal configured to be connected to an MIDI output terminal of the audio-music device;
a dongle output terminal configured to be connected to an MIDI input terminal of the audio-music device;
communication means configured to exchange various electronic information between the audio-music device and the other electronic device via the dongle input terminal and the dongle output terminal; and
a power-supply circuit configured to obtain power from a signal line in the MIDI scheme from the audio-music device via the dongle input terminal, to supply the power to the communication means, and to output the power to the MIDI input terminal of the audio-music device via the dongle output terminal,
wherein the power-supply circuit:
obtains the power from a power-supply signal line in the MIDI scheme from the audio-music device via the dongle input terminal;
supplies the obtained power to the communication means; and
supplies the power to a power-supply signal line of the MIDI input terminal of the audio-music device via the dongle output terminal.

8. The dongle device for audio-music devices according to claim 7, wherein the communication means comprises master-slave changing means that changes a master and a slave with communication means of the other electronic device.

9. The dongle device for audio-music devices according to claim 7, wherein:
the communication means comprises pairing means that mutually exchanges authentication codes with communication means of the other electronic device to execute pairing; and
upon operation given to a pairing start switch provided in the paring means, execution of the pairing starts.

10. The dongle device for audio-music devices according to claim 7, wherein:
the power-supply circuit comprises charging means; and
the power-supply circuit controls charging and discharging of the charging means to output power.

11. The dongle device for audio-music devices according to claim 7, wherein the communication means comprises wireless means.
